(19) United States
(12) Patent Application Publication
(10) Pub. No.: US 2026/0242583 A1
(43) Pub. Date: Aug. 20, 2026

(54) COMPOSITION AND MOLDED BODY

(71) Applicants: SUMITOMO CHEMICAL COMPANY, LIMITED, Chuo-ku, Tokyo (JP); NEWLIGHT TECHNOLOGIES, Inc., Huntington Beach, CA (US)

(72) Inventor: Kenta ISHIZUKA, Ichihara-shi, Chiba (JP)

(21) Appl. No.: 19/471,159

(22) PCT Filed: Mar. 4, 2024
(86) PCT No.: PCT/JP2024/008111

§ 371 Date: Sep. 30, 2025

(30) Foreign Application Priority Data
Apr. 6, 2023 (JP) 2023-062196

(51) Int. Cl. C08L 23/14; C08K 5/353

(52) U.S. Cl. CPC C08L 23/142; C08K 5/353; C08L 2205/03; C08L 2205/035

(57) ABSTRACT

A composition contains a polymer (A), an aliphatic polyester-based polymer (B), and a compound (C) having a carbon-carbon double bond. The compound (C) in the composition may include a compound containing at least one selected from the group consisting of a maleimide group, an acrylic group, a methacrylic group, an allyl group, and a styryl group. A molded body is formed by molding the composition.

### TECHNICAL FIELD

The present invention relates to a composition and a molded body.

### BACKGROUND ART

An aliphatic polyester-based polymer is a resin that can be synthesized by renewable resources without using fossil resources and has low environmental load, and is a resin excellent in molding processability and mechanical properties. For this reason, by adding the aliphatic polyester-based polymer to various packaging materials, various containers such as bottles, food packaging materials, container caps, stationery, daily goods, fibers for carpets and sofas, interior and exterior materials for automobiles, electrical and electronic components, building materials such as interior materials for buildings and houses, and the like, the environmental load can be reduced. In recent years, improvements in deterioration of mechanical properties due to degradation of the aliphatic polyester-based polymer by heating and light are often required for these articles.

For example, Patent Literature 1 describes a composition containing 100 parts by weight of a polyolefin, 1 to 100 parts by weight of an aliphatic polyester-based biodegradable polymer, and 0.1 to 100 parts by weight of an acid or epoxy group-containing polyolefin as a composition exhibiting an excellent physical property balance such as processability, impact resistance, and elastic modulus.

### CITATION LIST

### Patent Literature

Patent Literature 1: Japanese Unexamined Patent Application Publication No. 2006-077063

### SUMMARY OF INVENTION

### Technical Problem

However, the composition as described above may exhibit a strong odor, and the situations where the composition or the molded body thereof is applicable may be limited. Therefore, an object of the present invention is to provide a composition with reduced odor and a molded body thereof.

### Solution to Problem

The present invention includes the following [1] to [12].

[1] A composition containing:
a polymer (A);
an aliphatic polyester-based polymer (B); and
a compound (C) having a carbon-carbon double bond.

[2] The composition according to [1], in which the polymer (A) includes an olefin-based polymer.

[3] The composition according to [1] or [2], in which the polymer (A) includes a propylene-based polymer.

[4] The composition according to any one of [1] to [3], wherein the aliphatic polyester-based polymer (B) includes a polyhydroxyalkanoate-based polymer.

[5] The composition according to any one of [1] to [4], in which the compound (C) includes a compound containing at least one selected from the group consisting of a maleimide group, an acrylic group, a methacrylic group, an allyl group, and a styryl group.

[6] The composition according to any one of [1] to [5], in which the compound (C) includes a compound having a plurality of carbon-carbon double bonds (where, a carbon-carbon double bond constituting an aromatic ring is excluded).

[7] The composition according to any one of [1] to [6], in which the compound (C) is 0.3 to 100 parts by mass with respect to 100 parts by mass of the aliphatic polyester-based polymer (B).

[8] The composition according to any one of [1] to [7], in which the aliphatic polyester-based polymer (B) is 0.1 to 30 parts by mass and the compound (C) is 0.1 to 3 parts by mass, with respect to a total of 100 parts by mass of the polymer (A), the aliphatic polyester-based polymer (B), and the compound (C).

[9] The composition according to any one of [1] to [8], further containing
a filling material (D), in which
the filling material (D) is 0.1 to 40 parts by mass with respect to a total of 100 parts by mass of the polymer (A), the aliphatic polyester-based polymer (B), and the compound (C).

[10] The composition according to any one of [1] to [9], further containing
an oxazoline-based compound (E), in which
the oxazoline-based compound (E) is 0.1 to 10 parts by mass with respect to a total of 100 parts by mass of the polymer (A), the aliphatic polyester-based polymer (B), and the compound (C).

[11] The composition according to any one of [1] to [10], in which the oxazoline-based compound (E) is a compound having a plurality of oxazoline groups.

[12] The composition according to any one of [1] to [11], in which a molecular weight of the oxazoline-based compound (E) is 500 or less.

[13]A molded body formed by molding the composition according to any one of [1] to [12].

[14] The molded body according to [13], in which the molded body is a component for automobiles.

### Advantageous Effects of Invention

According to the present invention, it is possible to provide the composition with reduced odor and the molded body thereof.

### DESCRIPTION OF EMBODIMENTS

Hereinafter, some embodiments of the present invention will be described in detail. However, the present invention is not limited to the following embodiments.

### <Composition>

A composition (resin composition) according to one embodiment of the present invention contains a polymer (A), an aliphatic polyester-based polymer (B), and a compound (C) having a carbon-carbon double bond.

### <Polymer (A)>

The composition contains a polymer. The polymer may be an olefin-based polymer containing 50% by mass or more of a structural unit derived from an olefin having 2 or more and 10 or less carbon atoms (where, the total amount of the olefin-based polymer is defined as 100% by mass). Examples of the olefin having 2 or more and 10 or less carbon atoms include ethylene, propylene, 1-butene, 4-methyl-1-pentene, 1-hexene, 1-octene, and 1-decene.

The olefin-based polymer may contain a structural unit derived from a monomer except olefins having 2 or more and 10 or less carbon atoms. Examples of the monomer except olefins having 2 or more and 10 or less carbon atoms include aromatic vinyl monomers such as styrene; unsaturated carboxylic acids such as acrylic acid and methacrylic acid; unsaturated carboxylic acid esters such as methyl acrylate, ethyl acrylate, butyl acrylate, methyl methacrylate, and ethyl methacrylate; vinyl ester compounds such as vinyl acetate; conjugated dienes such as 1,3-butadiene and 2-methyl-1,3-butadiene (isoprene); and non-conjugated dienes such as dicyclopentadiene and 5-ethylidene-2-norbornene.

The olefin-based polymer may be at least one selected from the group consisting of an ethylene-based polymer, a propylene-based polymer, and a butene-based polymer, and may be a combination of two or more kinds thereof.

The ethylene-based polymer is a polymer containing 50% by mass or more of a structural unit derived from ethylene. Examples of the ethylene-based polymer include an ethylene homopolymer, an ethylene-based random copolymer, and an ethylene-based block copolymer. The ethylene-based polymer may be a combination of two or more ethylene-based polymers.

The propylene-based polymer is a polymer containing 50% by mass or more of a structural unit derived from propylene. Examples of the propylene-based polymer include a propylene homopolymer, a propylene-based random copolymer, and a propylene-based block copolymer. The propylene-based polymer may be a combination of two or more kinds of propylene-based polymers.

### (Propylene Homopolymer)

From the viewpoint of improving the fluidity of the composition and the toughness of a molded body of the composition, the propylene homopolymer has a limiting viscosity number [η] of preferably 0.1 to 2 dL/g, more preferably 0.5 to 1.9 dL/g, still more preferably 0.7 to 1.8 dL/g.

From the viewpoint of improving the fluidity of the composition and the toughness of a molded body of the composition, the propylene homopolymer has a molecular weight distribution Mw/Mn of preferably 3 or more and less than 7, and more preferably 3 to 5. Here, Mw represents a weight-average molecular weight, and Mn represents a number-average molecular weight. Note that the molecular weight distribution is a numerical value measured by gel permeation chromatography (GPC).

### (Propylene-Based Random Copolymer)

Examples of the propylene-based random copolymer include a random copolymer containing a propylene unit and an ethylene unit (hereinafter, referred to as a random copolymer (1)), a random copolymer containing a propylene unit and an α-olefin unit having 4 or more carbon atoms (hereinafter, referred to as a random copolymer (2)), and a random copolymer containing a propylene unit, an ethylene unit, and an α-olefin unit having 4 or more carbon atoms (hereinafter, referred to as a random copolymer (3)).

The α-olefin having 4 or more carbon atoms and capable of constituting the propylene-based random copolymer is preferably an α-olefin having 4 to 10 carbon atoms from the viewpoint of ease of odor reduction. Examples of the α-olefin having 4 to 10 carbon atoms include 1-butene, 1-pentene, 1-hexene, 4-methyl-1-pentene, 1-octene, and 1-decene, and 1-butene, 1-hexene, and 1-octene are preferable from the viewpoint of ease of odor reduction.

Examples of the random copolymer (2) include a propylene-1-butene random copolymer, a propylene-1-hexene random copolymer, a propylene-1-octene random copolymer, and a propylene-1-decene random copolymer.

Examples of the random copolymer (3) include a propylene-ethylene-1-butene copolymer, a propylene-ethylene-1-hexene copolymer, a propylene-ethylene-1-octene copolymer, and a propylene-ethylene-1-decene copolymer.

The content of the ethylene unit in the random copolymer (1) is preferably 0.1% to 40% by mass, more preferably 0.1% to 30% by mass, and still more preferably 2% to 15% by mass from the viewpoint of ease of odor reduction.

The content of the α-olefin unit having 4 or more carbon atoms in the random copolymer (2) is preferably 0.1% to 40% by mass, more preferably 0.1% to 30% by mass, and still more preferably 2% to 15% by mass from the viewpoint of ease of odor reduction.

The total content of the ethylene unit and the α-olefin unit having 4 or more carbon atoms in the random copolymer (3) is preferably 0.10% to 40% by mass, more preferably 0.1% to 30% by mass, and still more preferably 2% to 15% by mass from the viewpoint of ease of odor reduction.

The content of the propylene unit in the random copolymers (1) to (3) is preferably 60% to 99.9% by mass, more preferably 70% to 99.9% by mass, and still more preferably 85% to 98% by mass from the viewpoint of ease of odor reduction.

The polymer may be a heterophasic propylene polymer material. The heterophasic propylene polymer material means a propylene-based polymer (composition) containing the following polymer (I) and polymer (II), in which the polymer (I) and the polymer (II) are not compatible with each other and form different phases.

The polymer (I) is a propylene-based polymer containing a propylene unit in an amount of more than 80% by mass and 100% by mass or less when the amount of all constituent units is 100% by mass. The polymer (I) may be a propylene homopolymer or a copolymer of propylene and another monomer.

Examples of the monomer capable of constituting the polymer (I) except propylene include ethylene and an α-olefin having 4 or more carbon atoms.

The α-olefin having 4 or more carbon atoms and capable of constituting the polymer (I) is preferably an α-olefin having 4 to 10 carbon atoms, more preferably 1-butene, 1-hexene, and 1-octene, and still more preferably 1-butene from the viewpoint of ease of odor reduction.

Examples of the polymer (I) include a propylene homopolymer, a propylene-ethylene copolymer, a propylene-1-butene copolymer, a propylene-1-hexene copolymer, a propylene-1-octene copolymer, a propylene-ethylene-1-butene copolymer, a propylene-ethylene-1-hexene copolymer, and a propylene-ethylene-1-octene copolymer.

Among them, the polymer (I) is preferably a propylene homopolymer, a propylene-ethylene copolymer, a propylene-1-butene copolymer, and a propylene-ethylene-1-butene copolymer from the viewpoint of ease of odor reduction, and more preferably a propylene homopolymer from the viewpoint of the rigidity of a molded body containing the composition.

The molecular weight distribution (Mw/Mn) of the polymer (I) measured by GPC is preferably 3 or more and less than 7 and more preferably 3 to 5.

The polymer (II) is a propylene-based polymer which is a copolymer of a propylene unit and at least one monomer unit selected from the group consisting of an ethylene unit and an α-olefin unit having 4 or more carbon atoms.

The total content of the ethylene unit and the α-olefin unit having 4 or more carbon atoms in the polymer (II) is preferably 20% to 80% by mass and more preferably 20% to 60% by mass from the viewpoint of ease of odor reduction.

The α-olefin having 4 or more carbon atoms and capable of constituting the polymer (II) is preferably an α-olefin having 4 to 10 carbon atoms from the viewpoint of ease of odor reduction. Examples of the α-olefin capable of constituting the polymer (II) include similar examples to the above examples of the α-olefin capable of constituting the polymer (I).

Examples of the polymer (II) include a propylene-ethylene copolymer, a propylene-ethylene-1-butene copolymer, a propylene-ethylene-1-hexene copolymer, a propylene-ethylene-1-octene copolymer, a propylene-ethylene-1-decene copolymer, a propylene-1-butene copolymer, a propylene-1-hexene copolymer, a propylene-1-octene copolymer, and from the viewpoint of ease of odor reduction, a propylene-1-decene copolymer, a propylene-ethylene copolymer, a propylene-1-butene copolymer, and a propylene-ethylene-1-butene copolymer are preferable, and a propylene-ethylene copolymer is more preferable.

From the viewpoint of ease of odor reduction, the content of the polymer (II) in the heterophasic propylene polymer material is preferably 1% to 50% by mass, more preferably 1% to 40% by mass, still more preferably 5% to 30% by mass, and particularly preferably 8% to 15% by mass when the total content of the polymer (I) and the polymer (II) is 100% by mass.

As each of the polymer (I) and the polymer (II), one kind of polymer may be used alone, or two or more kinds of polymers may be used in combination.

Examples of the heterophasic propylene polymer material include a combination of a propylene homopolymer and a (propylene-ethylene) copolymer, a combination of a propylene homopolymer and a (propylene-ethylene-1-butene) copolymer, a combination of a propylene homopolymer and a (propylene-ethylene-1-hexene) copolymer, a combination of a propylene homopolymer and a (propylene-ethylene-1-octene) copolymer, a combination of a propylene homopolymer and a (propylene-1-butene) copolymer, a combination of a propylene homopolymer and a (propylene-1-hexene) copolymer, a combination of a propylene homopolymer and a (propylene-1-octene) copolymer, and a combination of a propylene homopolymer and a (propylene-1-decene) copolymer, in which the polymer (I) is a propylene homopolymer.

Furthermore, other examples of the heterophasic propylene polymer material include a combination of a (propylene-ethylene) copolymer and a (propylene-ethylene) copolymer, a combination of a (propylene-ethylene) copolymer and a (propylene-ethylene-1-butene) copolymer, a combination of a (propylene-ethylene) copolymer and a (propylene-ethylene-1-hexene) copolymer, a combination of a (propylene-ethylene) copolymer and a (propylene-ethylene-1-octene) copolymer, a combination of a (propylene-ethylene) copolymer and a (propylene-ethylene-1-decene) copolymer; a combination of a (propylene-ethylene) copolymer and a (propylene-1-butene) copolymer, a combination of a (propylene-ethylene) copolymer and a (propylene-1-hexene) copolymer, a combination of a (propylene-ethylene) copolymer and a (propylene-1-octene) copolymer, a combination of a (propylene-ethylene) copolymer and a (propylene-1-decene) copolymer, a combination of a (propylene-1-butene) copolymer and a (propylene-ethylene) copolymer, a combination of a (propylene-1-butene) copolymer and a (propylene-ethylene-1-butene) copolymer, a combination of a (propylene-1-butene) copolymer and a (propylene-ethylene-1-hexene) copolymer, a combination of a (propylene-1-butene) copolymer and a (propylene-ethylene-1-octene) copolymer, a combination of a (propylene-1-butene) copolymer and a (propylene-ethylene-1-decene) copolymer, a combination of a (propylene-1-butene) copolymer and a (propylene-1-butene) copolymer, a combination of a (propylene-1-butene) copolymer and a (propylene-1-hexene) copolymer, a combination of a (propylene-1-butene) copolymer and a (propylene-1-octene) copolymer, a combination of a (propylene-1-butene) copolymer and a (propylene-1-decene) copolymer; a combination of a (propylene-1-hexene) copolymer and a (propylene-1-hexene) copolymer, a combination of a (propylene-1-hexene) copolymer and a (propylene-1-octene) copolymer, a combination of a (propylene-1-hexene) copolymer and a (propylene-1-decene) copolymer; and a combination of a (propylene-1-octene) copolymer and a (propylene-1-octene) copolymer, a combination of a (propylene-1-octene) copolymer and a (propylene-1-decene) copolymer, in which the polymer (I) is a polymer containing a propylene unit and a monomer unit except the propylene unit. Note that, in the examples of the above combination, the polymer (I) is described first, and the polymer (II) is described later.

From the viewpoint of ease of odor reduction, the heterophasic propylene polymer material that can be contained in the composition is preferably a combination of (a propylene homopolymer and a (propylene-ethylene) copolymer, a combination of a propylene homopolymer and a (propylene-ethylene-1-butene) copolymer, a combination of a (propylene-ethylene) copolymer and a (propylene-ethylene) copolymer, a combination of a (propylene-ethylene) copolymer and a (propylene-ethylene-1-butene) copolymer, and a combination of a (propylene-1-butene) copolymer and a (propylene-1-butene) copolymer, and more preferably a combination of a propylene homopolymer and a (propylene-ethylene) copolymer.

The heterophasic propylene polymer material can be produced by a production method including a multistage polymerization step including a first polymerization step of generating the polymer (I) and a second polymerization step of generating the polymer (II) in the presence of the polymer (I) generated in the first polymerization step. Polymerization of the heterophasic propylene polymer material can be performed using the catalyst exemplified as the above catalyst that can be used for producing a polypropylene-based polymer.

From the viewpoint of ease of odor reduction, the limiting viscosity number (hereinafter, referred to as [η]_{I}) of the polymer (I) is preferably 0.1 to 2 dL/g, more preferably 0.5 to 1.5 dL/g, and still more preferably 0.7 to 1.3 dL/g.

From the viewpoint of ease of odor reduction, the limiting viscosity number (hereinafter, referred to as [η]_{II}) of the polymer (II) is preferably 1 to 10 dL/g, more preferably 2 to 10 dL/g, and still more preferably 5 to 8 dL/g.

From the viewpoint of ease of odor reduction, a ratio of [η]_{II} to [η]_{I} ([η]_{II}/[η]_{I}) is preferably 1 to 20, more preferably 2 to 10, and still more preferably 2 to 9.

In a case where the polypropylene-based polymer is a heterophasic propylene polymer material composed of the polymer (I) and the polymer (II) formed by the multistage polymerization step as described above, a part of the polymer (I) generated in the first polymerization step is extracted from a polymerization tank in which the first polymerization step has been performed, the limiting viscosity number thereof is determined, the limiting viscosity number (hereinafter, referred to as [η]_{Total}) of the heterophasic propylene polymer material finally generated in the second polymerization step is determined, and the limiting viscosity number of the polymer (II) generated in the second polymerization step is calculated using these limiting viscosity numbers and the contents.

When the heterophasic propylene polymer material composed of the polymer (I) and the polymer (II) is produced by a production method in which the polymer (I) is obtained in the first polymerization step and the polymer (II) is obtained in the second polymerization step, the content of each of the polymer (I) and the polymer (II) and a procedure of measuring and calculating the limiting viscosity numbers ([η]_{Total}, [η]_{I}, and [η]_{II}) are as follows.

From the limiting viscosity number ([η]_{I}) of the polymer (I) obtained in the first polymerization step, the limiting viscosity number ([η]_{Total}) measured by the method described above for the final polymer (that is, the heterophasic propylene polymer material composed of the polymer (I) and the polymer (II)) obtained in the second polymerization step, and the content of the polymer (II) contained in the final polymer, the limiting viscosity number [η]_{II} of the polymer (II) is calculated by the following formula.

$${[ η ]}_{II} = ( {[ η ]}_{Total} - {[ η ]}_{I} \times {X}_{I} ) / {X}_{I I} \qquad Formula$$

In the formula,

[η]_{Total} represents the limiting viscosity number (unit: dL/g) of the final polymer,
[η]₁ represents the limiting viscosity number (unit: dL/g) of the polymer (I),
X_{I} represents a mass ratio of the polymer (I) to the final polymer, and
X_{II} represents a mass ratio of the polymer (II) to the final polymer.

Note that X_{I} and X_{II} can be determined from a mass balance in the polymerization step.

Here, the mass ratio X_{II} of the polymer (II) to the final polymer may be calculated by the following formula using the crystal melting heat amount of each of the polymer (I) and the final polymer.

$${X}_{II} = 1 - {( Δ Hf )}_{T} / {( Δ Hf )}_{P} \qquad Formula$$

In the formula,
(ΔHf)_{T} represents the melting heat amount (unit: cal/g) of the final polymer (polymer (I) and polymer (II)), and
(ΔHf)ₚ represents the melting heat amount (unit: cal/g) of the polymer (I).

From the viewpoint of further improving the rigidity of a molded body of the composition, the propylene-based polymer may have an isotactic pentad fraction (also referred to as a [mmmm] fraction) of 0.961 or more, preferably 0.97 or more, more preferably 0.98 or more as measured by ¹³C-NMR.

It can be said that the closer the isotactic pentad fraction of the propylene-based polymer is to 1, the higher stereoregularity of a molecular structure of the propylene-based polymer is, and the higher crystallinity of the polypropylene-based polymer is.

When the propylene-based polymer is a copolymer, the isotactic pentad fraction can be measured for a chain of propylene units in the copolymer.

The propylene-based polymer can be produced, for example, by a polymerization method using a polymerization catalyst.

Examples of the polymerization catalyst include a Ziegler type catalyst, a Ziegler-Natta type catalyst, a catalyst containing a compound containing a transition metal element of Group 4 of the periodic table and having a cyclopentadienyl ring and an alkylaluminoxane, a catalyst containing a compound containing a transition metal element of Group 4 of the periodic table and having a cyclopentadienyl ring, a compound that reacts with the compound to form an ionic complex, and an organic aluminum compound, and a catalyst in which a catalyst component (for example, a compound containing a transition metal element of Group 4 of the periodic table and having a cyclopentadienyl ring, a compound that forms an ionic complex, an organic aluminum compound, or the like) is supported on inorganic particles (for example, silica, clay minerals, or the like) and modified.

As the polymerization catalyst, a prepolymerization catalyst prepared by prepolymerizing a monomer such as ethylene or an α-olefin in the presence of a catalyst may be used.

Examples of the Ziegler-Natta type catalyst include a catalyst in which a titanium-containing solid transition metal component and an organometallic component are combined.

Specific examples of the above polymerization catalyst include conventionally known catalysts described in Japanese Unexamined Patent Application Publication Nos. S61-218606, 115-194685, H7-216017, 119-316147, H10-212319, and 2004-182981.

Examples of the polymerization method include bulk polymerization, solution polymerization, and gas phase polymerization. Here, the bulk polymerization refers to a method for performing polymerization using a liquid olefin as a medium at a polymerization temperature. The solution polymerization refers to a method for performing polymerization in an inert hydrocarbon solvent such as propane, butane, isobutane, pentane, hexane, heptane, or octane. The gas phase polymerization refers to a method for polymerizing a monomer in a gaseous state in a medium which is the monomer in a gaseous state.

Examples of a method in the above polymerization method (polymerizing method) include a batch method, a continuous method, and a combination thereof. The polymerizing method may be a multistage method performed using a plurality of polymerization reaction tanks connected in series.

As various conditions (polymerization temperature, polymerization pressure, monomer concentration, catalyst putting amount, polymerization time, and the like) in a polymerization step according to the above polymerization method, any suitable conditions can be appropriately determined according to an intended propylene-based polymer.

In producing the propylene-based polymer, in order to remove a residual solvent contained in the propylene-based polymer polymerized by the above polymerization method and an impurity such as an oligomer by-produced in the polymerization step, the propylene-based polymer polymerized by the above polymerization method may be held, for example, at a temperature at which a residual solvent or an impurity such as an oligomer can be volatilized and at a temperature at which the propylene-based polymer cannot be melted, modified, or the like. Examples of such a method for removing an impurity include any conventionally known suitable methods described in Japanese Unexamined Patent Application Publication No. S55-75410, Japanese Patent No. 2565753, and the like.

The composition may contain an ethylene-α-olefin copolymer as a polymer. The ethylene-α-olefin copolymer is a copolymer of ethylene and an α-olefin, the copolymer containing more than 50% by mass of a structural unit derived from ethylene. The content of the structural unit derived from ethylene in the ethylene-α-olefin copolymer may be 60% by mass or more, or 70% by mass or more.

The ethylene-α-olefin copolymer may be a copolymer having a monomer unit derived from an α-olefin having 3 to 20 carbon atoms and a monomer unit derived from ethylene. Examples of the α-olefin having 3 to 20 carbon atoms include propylene, 1-butene, isobutene, 1-pentene, 2-methyl-1-butene, 3-methyl-1-butene, 1-hexene, 2-methyl-1-pentene, 3-methyl-1-pentene, 4-methyl-1-pentene, 1-octene, 1-nonene, 1-decene, 1-undecene, and 1-dodecene, and propylene, 1-butene, 1-hexene, or 1-octene is preferable from the viewpoint of ease of odor reduction.

Examples of the ethylene-α-olefin copolymer include an ethylene-propylene copolymer, an ethylene-1-butene copolymer, an ethylene-1-hexene copolymer, and an ethylene-1-octene copolymer, and an ethylene-1-butene-1-hexene copolymer. The ethylene-α-olefin copolymer may be used singly, or in combination of two or more thereof. From the viewpoint of ease of odor reduction, an ethylene-1-butene copolymer or an ethylene-1-octene copolymer is preferable.

The melt mass flow rate (MFR) of the polymer measured under the conditions of a temperature of 230° C. and a load of 2.16 kg in accordance with JIS K7210-2014 may be 0.1 g/10 min or more, 1 g/10 min or more, 10 g/10 min or more, 20 g/10 min or more, or 30 g/10 min or more, and is 200 g/10 min or less, 150 g/10 min or less, 100 g/10 min or less, 80 g/10 min or less, 60 g/10 min or less, or 40 g/10 min or less.

### <Aliphatic Polyester-Based Polymer (B)>

The composition contains an aliphatic polyester-based polymer. The aliphatic polyester-based polymer has a structure of a polycondensate of an aliphatic polyvalent carboxylic acid component and an aliphatic polyhydric alcohol component or a polycondensate of an aliphatic hydroxycarboxylic acid, and the main chain of the repeating unit does not contain an aromatic hydrocarbon structure.

Examples of the aliphatic polyester-based polymer include a polymer of a hydroxycarboxylic acid or a lactone, a polycondensate of a diol and a dicarboxylic acid, and a copolymer thereof. In a case where the aliphatic polyester-based polymer is a copolymer, the form of arrangement of the copolymer may be any form of a random copolymer, an alternating copolymer, a block copolymer, a graft copolymer, and the like.

The aliphatic polyester-based polymer may be one in which at least a part thereof is crosslinked with a crosslinking agent such as a polyvalent isocyanate, such as xylylene diisocyanate or 2,4-tolylene diisocyanate, or a polysaccharide, such as cellulose, acetyl cellulose, or ethyl cellulose. The aliphatic polyester-based polymer may be one in which at least a part thereof may have any structure of linear, cyclic, branched, star, three-dimensional network structures, and the like, there is no any limitation, and the aliphatic polyester-based polymer may be a copolymer with a polyolefin-based resin or a graft polymer with a polyolefin-based resin. The aliphatic polyester-based polymer may be used alone or in combination of two or more kinds thereof.

Examples of the hydroxycarboxylic acid include hydroxycarboxylic acids having 2 to 18 carbon atoms. From the viewpoint of ease of odor reduction, a hydroxycarboxylic acid having 6 or less carbon atoms is preferable, and a hydroxycarboxylic acid having 4 carbon atoms is most preferable. Specific examples of the hydroxycarboxylic acid include glycolic acid, L-lactic acid, D-lactic acid, D,L-lactic acid, 3-hydroxybutyrate, 3-hydroxyvalerate, 3-hydroxypropionate, 4-hydroxybutyrate, 4-hydroxyvalerate, 5-hydroxyvalerate, 3-hydroxypentenoate, 3-hydroxyhexanoate, 3-hydroxyheptanoate, 3-hydroxyoctanoate, 3-hydroxynonanoate, and 3-hydroxydecanoate.

Examples of the lactone include propiolactone, butyrolactone, valerolactone, caprolactone, and laurolactone.

From the viewpoint of ease of odor reduction, the diol is preferably a diol having 2 to 10 carbon atoms. Among them, from the viewpoint of ease of odor reduction, an aliphatic diol having 2 to 4 carbon atoms is more preferable, and an alicyclic diol having 5 to 6 carbon atoms is still more preferable. Specific examples of the diol include ethylene glycol, 1,3-propanediol, 1,4-butanediol, 1,2-butanediol, 1,5-pentanediol, 1,6-hexanediol, 1,8-octanediol, 1,10-decanediol, 1,12-dodecanediol, 1,14-tetradecanediol, 1,16-hexadecanediol, 1,18-octadecanediol, 1,2-cyclohexanediol, 1,4-cyclohexanediol, 1,2-cyclohexanedimethylol, and 1,4-cyclohexanedimethylol.

From the viewpoint of ease of odor reduction, the dicarboxylic acid is preferably an aliphatic dicarboxylic acid having 2 to 12 carbon atoms. Among them, from the viewpoint of ease of odor reduction, an aliphatic dicarboxylic acid having 2 to 6 carbon atoms is more preferable, and an alicyclic dicarboxylic acid having 5 to 6 carbon atoms is still more preferable. Specific examples of the dicarboxylic acid include oxalic acid, malonic acid, succinic acid, glutaric acid, adipic acid, pimelic acid, suberic acid, azelaic acid, sebacic acid, undecadicarboxylic acid, dodecadicarboxylic acid, 1,14-tetradecanedicarboxylic acid, 1,16-hexadecanedicarboxylic acid, 1,18-octadecanedicarboxylic acid, a dimer acid and a hydrogenated product thereof, hexahydrophthalic acid, hexahydroisophthalic acid, and hexahydroterephthalic acid. These dicarboxylic acids may be derivatives such as an alkyl ester having 1 to 4 carbon atoms and an acid anhydride.

Among the aliphatic polyester-based polymers, from the viewpoint of ease of odor reduction, it is preferable to use polylactic acid or polybutylene succinate, poly(butylene succinate-co-butylene adipate), polycaprolactone, poly(3-hydroxybutyrate), poly(3-hydroxybutyrate-co-3-hydroxyhexanoate), and polyglycolic acid.

In a case where polylactic acid is used as the aliphatic polyester-based polymer, the polylactic acid is preferably one in which the proportion of the L-form in the lactic acid component constituting the polylactic acid is preferably 94% by mol or more. By setting the proportion of the L-form in such a range, it is possible to prevent a decrease in melting point.

The aliphatic polyester-based polymer B may be a poly(3-hydroxyalkanoate)-based polymer having a melting point of 150° C. or higher. The poly(3-hydroxyalkanate)-based polymer is a polyhydroxyalkanoate (that is, a polyester of a hydroxyalkanoic acid), and contains a repeating unit of 3-hydroxyalkanate represented by the following formula (1).

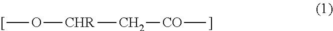

In formula (1), R is a hydrogen atom, a halogen atom, an alkyl group having 1 to 15 carbon atoms, a cyano group, an amino group having 1 to 18 carbon atoms, an alkoxy group (alkyloxy group) having 1 to 11 carbon atoms, an amide group having 1 to 20 carbon atoms, an aryl group having 6 to 12 carbon atoms, or a monovalent heterocyclic group having 1 to 9 carbon atoms. These groups may have a substituent. From the viewpoint of compatibility with a component other than the polyhydroxyalkanoate-based polymer (B), R may be an alkyl group having 1 to 8 carbon atoms, an amide group having 1 to 20 carbon atoms, or an aryl group having 6 to 8 carbon atoms.

Examples of the halogen atom include F, Cl, Br, and I.

The alkyl group having 1 to 15 carbon atoms may be linear or branched. The alkyl group may have 1 to 8 carbon atoms or 1 to 4 carbon atoms. Examples of the alkyl group include a methyl group, an ethyl group, a propyl group, an isopropyl group, a butyl group, an isobutyl group, a sec-butyl group, a tert-butyl group, a pentyl group, an isopentyl group, a 2-methylbutyl group, a 1-methylbutyl group, a hexyl group, an isohexyl group, a 3-methylpentyl group, a 2-methylpentyl group, a 1-methylpentyl group, a heptyl group, an octyl group, an isooctyl group, a 2-ethylhexyl group, a 3,7-dimethyloctyl group, a nonyl group, a decyl group, an undecyl group, a dodecyl group, a tetradecyl group, and a pentadecyl group.

Examples of the amino group having 1 to 18 or 1 to 11 carbon atoms include an amino group, an alkylamino group, a dialkylamino group, an arylamino group, an alkylarylamino group, a benzylamino group, and a dibenzylamino group.

Examples of the alkylamino group include a methylamino group, an ethylamino group, a propylamino group, a butylamino group, a pentylamino group, a hexylamino group, a heptylamino group, an octylamino group, a nonylamino group, a decylamino group, a dodecylamino group, an isopropylamino group, an isobutylamino group, an isopentylamino group, a sec-butylamino group, a tert-butylamino group, a sec-pentylamino group, a tert-pentylamino group, a tert-octylamino group, a neopentylamino group, a cyclopropylamino group, a cyclobutylamino group, a cyclopentylamino group, a cyclohexylamino group, a cycloheptylamino group, a cyclooctylamino group, a 1-adamantamino group, and 2-adamantamino group.

Examples of the dialkylamino group include a dimethylamino group, a diethylamino group, a dipropylamino group, a dibutylamino group, a dipentylamino group, a diisopropylamino group, a diisobutylamino group, a diisopentylamino group, a methylethylamino group, a methylpropylamino group, a methylbutylamino group, a methylisobutylamino group, a dicyclopropylamino group, a pyrrolidino group, a piperidino group, and a piperazino group.

Examples of the arylamino group include an anilino group, a 1-naphthylamino group, a 2-naphthylamino group, an o-toluidino group, a m-toluidino group, a p-toluidino group, a 1-fluoreneamino group, a 2-fluoreneamino group, a 2-thiazoleamino group, and a p-terphenylamino group.

Examples of the alkylarylamino group include an N-methylanilino group, an N-ethylanilino group, an N-propylanilino group, an N-butylanilino group, an N-isopropylanilino group, and an N-pentylanilino group.

Examples of the alkoxy group having 1 to 11 carbon atoms include a methoxy group, an ethoxy group, a propoxy group, an isopropoxy group, a butoxy group, an isobutoxy group, a sec-butoxy group, a tert-butoxy group, a cyclopropoxy group, a cyclobutoxy group, and a cyclopentoxy group.

The “amide group” means a group obtained by removing one hydrogen atom bonded to a nitrogen atom from a carboxylic amide. Examples of the amide group having 1 to 20 carbon atoms include a group represented by —NH—C(═O)—R^{A} (provided that, R^{A} is a hydrogen atom or a monovalent organic group) such as a formamide group, an acetamide group, a propionamide group, a butyramide group, a benzamide group, a trifluoroacetamide group, or a pentafluorobenzamide group; and a group represented by —N(—C(═O)—R ^{A})(—C(═O)—R^{B}) (where, R^{A} and R^{B} are each independently a hydrogen atom or a monovalent organic group) such as a diformamide group, a diacetamide group, a dipropioamide group, a dibutyroamide group, a dibenzamide group, a ditrifluoroacetamide group, or a dipentafluorobenzamide group. The organic group is an alkyl group, an alkoxy group, or an aryl group, and may be substituted with a halogen atom. The amide group may be a formamide group, an acetamide group, a propionamide group, a butyroamide group, or a benzamide group.

Examples of the aryl group having 6 to 12 carbon atoms include a phenyl group, a tolyl group, a xylyl group, a naphthyl group, and a biphenyl group. The aryl group having 6 to 12 carbon atoms may be a phenyl group, a tolyl group, or a xylyl group.

Examples of the heteroatom of the monovalent heterocyclic group having 1 to 9 carbon atoms include N, O, and S, may be saturated or unsaturated, may have a single heteroatom or a plurality of heteroatoms, and may have different types of heteroatoms. Examples of such a heterocyclic group include a thienyl group, a pyrrolyl group, a furyl group, a pyridyl group, a piperidinyl group, a quinolinyl group, an isoquinolinyl group, a pyrimidinyl group, a triazinyl group, and a thiazolyl group.

The repeating unit of the polyhydroxyalkanoate-based polymer may consist only of one or more kinds of 3-hydroxyalkanoate represented by formula (1), and may consist of one or more kinds of 3-hydroxyalkanoate represented by formula (1) and one or more kinds of other hydroxyalkanoates.

From the viewpoint of ease of odor reduction, the polyhydroxyalkanoate-based polymer preferably contains 50% by mol or more, and more preferably 70% by mol or more, of the repeating unit of 3-hydroxylkanoate represented by formula (1) with respect to the total repeating unit (100% by mol) of the hydroxyalkanoate.

Examples of the 3-hydroxyalkanoate represented by formula (1) include, in a case where R is a hydrogen atom or an alkyl group represented by CₙH₂ₙ₊₁ and n is an integer of 1 to 15, 3-hydroxybutyrate with n=1 (hereinafter, sometimes referred to as 3 HB), 3-hydroxyvalerate with n=2 (hereinafter, sometimes referred to as 3HV), 3-hydroxyhexanoate with n=3 (hereinafter, sometimes referred to as 3HH), 3-hydroxyoctanoate with n=5, 3-hydroxyoctadecanoate with n=15, and 3-hydroxypropionate in which R is a hydrogen atom.

Examples of the polyhydroxyalkanoate-based polymer having only one repeating unit represented by formula (1) include poly(3-hydroxybutyrate) (hereinafter, sometimes referred to as P3 HB).

Examples of the polyhydroxyalkanoate-based polymer having only a plurality of repeating units represented by formula (1) include poly(3-hydroxybutyrate-co-3-hydroxyhexanoate (hereinafter, sometimes referred to as P3 HB3HH), poly(3-hydroxybutyrate-co-3-hydroxyvalerate (hereinafter, sometimes referred to as P3 HB3HV), and poly(3-hydroxybutyrate-co-3-hydroxypropionate (hereinafter, sometimes referred to as P3 HB3HP).

Examples of the other hydroxyalkanoates other than 3-hydroxyalkanoate represented by formula (1) include a repeating unit represented by formula (2).

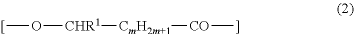

In formula (2), R¹ is a hydrogen atom or an alkyl group represented by CₙH₂ₙ₊₁, n is an integer of 1 or more and 15 or less, and m is an integer of 2 to 10.

Examples of the polyhydroxyalkanoate-based polymer containing the repeating units of formula (1) and formula (2) include poly(3-hydroxybutyrate-co-4-hydroxybutyrate) (hereinafter, sometimes referred to as P3 HB4 HB).

From the viewpoint of increasing the melting point and the viewpoint of ease of odor reduction, it is preferable that the repeating unit of the polyhydroxyalkanoate-based polymer contains at least 3-hydroxybutyrate among the 3-hydroxyalkanoates represented by formula (1).

From the viewpoint of ease of odor reduction, the polyhydroxyalkanoate-based polymer preferably contains 50% by mol or more, and more preferably 70% by mol or more, of the repeating unit of 3-hydroxybutyrate with respect to the total repeating unit (100% by mol) of the hydroxyalkanoate.

The polyhydroxyalkanoate-based polymer may have two or more repeating units of ester, and may be, for example, a di-copolymer having two repeating units as described above, a tri-copolymer having three repeating units, and a tetra-copolymer having four repeating units.

Examples of the tri-copolymer include poly(3-hydroxybutyrate-co-3-hydroxyvalylate-co-3-hydroxyhexanoate) (hereinafter, sometimes referred to as (P3 HB3HV3HH)).

As described above, from the viewpoint of ease of odor reduction, the polyhydroxyalkanoate-based polymer preferably contains 3 -hydroxybutyrate among the repeating units of 3-hydroxyalkanoate represented by formula (1). A ratio XX of the repeating unit of 3-hydroxybutyrate to 100 mol of the ester repeating unit of the total hydroxyalkanoate is preferably 90% by mol or more, more preferably 95% by mol or more, and still more preferably 98% by mol or more from the viewpoint of ease of odor reduction. The ratio XX is usually 100% by mol or less, and may be 99.9% by mol or less, or may be 99.8% by mol or less.

The form of arrangement of the copolymer may be any form of a random copolymer, an alternating copolymer, a block copolymer, a graft copolymer, and the like.

The polyhydroxyalkanoate-based polymer may have another ester repeating unit in addition to those of formula (1) and formula (2), but the main chain of the other ester repeating unit does not contain an aromatic hydrocarbon structure. That is, the polyhydroxyalkanoate-based polymer is an aliphatic polyester. However, a group having an aromatic hydrocarbon group is bonded to carbon in the main chain of the other ester repeating unit.

As described in L. Tripathi., M. C. Factories, 11, 44 (2012), the composition ratio of the repeating unit in the polyhydroxyalkanoate-based polymer can be determined by calculation from the results of NNMR measurement such as ¹H-NMR or ¹³C-NMR.

Furthermore, the polyhydroxyalkanoate-based polymer may be a blend of two or more kinds of polyhydroxyalkanoate-based polymers.

The weight-average molecular weight (Mw) of the polyhydroxyalkanoate-based polymer may be 10000 to 1000000, and is preferably 20000 to 800000 and more preferably 30000 to 600000. When the weight-average molecular weight is 10000 or more, a molded body excellent in impact strength and tensile elongation can be obtained. When the weight-average molecular weight is 500000 or less, the polyhydroxyalkanoate-based polymer has excellent dispersibility. The weight-average molecular weight may be 400000 or less, 300000 or less, 200000 or less, or 100000 or less. Note that, in the present specification, the weight-average molecular weight (Mw) is measured by GPC using standard polystyrene as a molecular weight standard substance.

The polyhydroxyalkanoate-based polymer may be a thermoplastic resin, and is suitably crystalline.

The melt mass flow rate (MFR) of the polyhydroxyalkanoate-based polymer as measured in accordance with JIS K7210-2014 under the conditions of a temperature of 190° C. and a load of 2.16 kgf is preferably 0.1 g/10 min or more and 200 g/10 min or less from the viewpoint of ease of odor reduction. The MFR of the polyhydroxyalkanoate-based polymer may be 0.5 g/10 min or more, 1 g/10 min or more, 1.5 g/10 min or more, or 2 g/10 min or more. The MFR of the polyhydroxyalkanoate-based polymer may be 150 g/10 min or less, 100 g/10 min or less, 70 g/10 min or less, 50 g/10 min or less, 30 g/10 min or less, or 20 g/10 min or less.

The melting point (Tm) of the polyhydroxyalkanoate-based polymer may be 150° C. or higher, 155° C. or higher, 160° C. or higher, 165° C. or higher, 170° C. or higher, or 175° C. or higher. The melting point (Tm) of the polyhydroxyalkanoate-based polymer may be 220° C. or lower, 200° C. or lower, or 190° C. or lower.

The melting point (Tm) of the polyhydroxyalkanoate-based polymer is measured by the position of a main peak based on melting of a crystal obtained by differential scanning calorimetry (DSC) measurement in accordance with JIS K7121.

The polyhydroxyalkanoate-based polymer may be produced by microorganisms, and may be derived from a compound (for example, a cyclic lactone or the like) derived from a petroleum or plant source.

In the polyhydroxyalkanoate-based polymer, each repeating unit of the hydroxyalkanate may consist of only the D-form (R-form) as in the case of a polymer produced from a microorganism, or the repeating unit of the hydroxyalkanoate may include both the D-form (R-form) and the L-form (S-form) as in the case of a polymer derived from a mixture of the D-form (R-form) and the L-form (S-form).

In a poly(3-hydroxyalkanoate)-based polymer produced from a microorganism, the repeating unit of formula (1) can be represented as the following formula. In formula (BI-1), n represents the degree of polymerization.

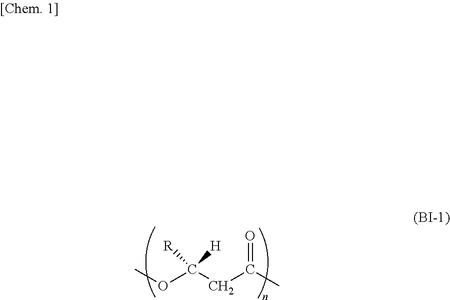

Poly-(3-hydroxybutyrate) produced from a microorganism has, for example, the following structure. In formula (BI-2), n represents the degree of polymerization.

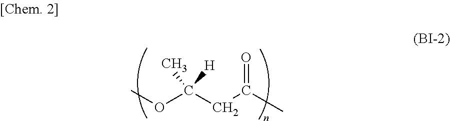

Poly-(3-hydroxybutyrate-co-3-hydroxyhexanoate) produced from a microorganism has, for example, the following structure. In formula (BI-3), m and n represent the degree of polymerization.

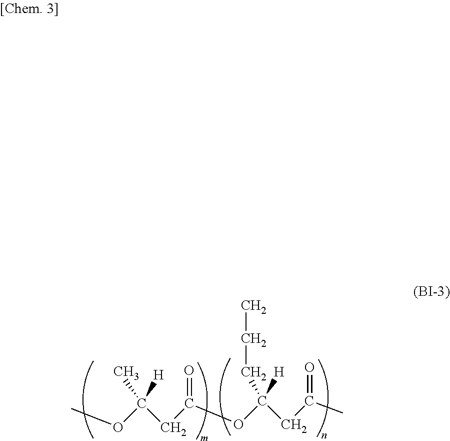

Poly-(3-hydroxybutyrate-co-4-hydroxybutyrate) produced from a microorganism has, for example, the following structure. In formula (BI-4), m and n represent the degree of polymerization.

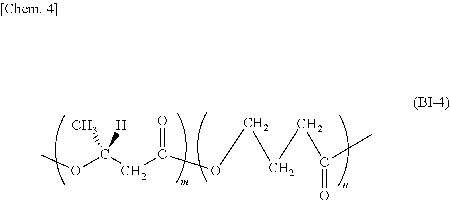

The polyhydroxyalkanoate-based polymer can be biodegradable.

The poly(3-hydroxyalkanoate)-based polymer can be produced by, for example, microorganisms such as Alcaligenes eutrophus AC32 strain in which PHA synthase enzyme gene derived from Aeromonascaviae was introduced into Alcaligeneseutrophus (international deposit under the Budapest Treaty, international depositary authority: National Institute of Advanced Industrial Science and Technology Center (Center 6, 1-1-1 Higashi, Tsukuba City, Ibaraki Prefecture, Japan), original deposit date: Aug. 12, 1996, transferred on Aug. 7, 1997, accession number FERM1BP-6038 (transferred from original deposit FERMP-15786)) (J. Bacteriol., 179, 4821 (1997)).

### <Compound (C) Having Carbon-Carbon Double Bond>

The composition contains a compound having a carbon-carbon double bond (hereinafter, also simply referred to as a “compound (C)”). When the composition contains the compound (C), odor can be reduced. For this reason, the inventors infer that odor can be reduced by reaction of carbon-carbon double bonds of the compound (C) with a causative substance of odor. However, the mechanism of the effect exhibited by the present invention is not limited to the above.

From the viewpoint of ease of odor reduction, the carbon-carbon double bond of the compound (C) is preferably a carbon-carbon double bond other than a carbon-carbon double bond constituting an aromatic ring. From the viewpoint of ease of odor reduction, the compound (C) preferably has a plurality of carbon-carbon double bonds, and more preferably has a plurality of carbon-carbon double bonds (where, a carbon-carbon double bond constituting an aromatic ring is excluded).

The compound (C) may have a functional group other than a carbon-carbon double bond. From the viewpoint of ease of odor reduction, the compound (C) preferably includes a compound containing at least one selected from the group consisting of a maleimide group, an acrylic group, a methacrylic group, an allyl group, and a styryl group. The compound (C) may have an aromatic ring or may not have an aromatic ring.

Examples of the compound (C) include N,N′-m-phenylene bismaleimide, triallyl isocyanurate, triallyl cyanurate, divinylbenzene, ethylene glycol dimethacrylate, polyethylene glycol dimethacrylate, trimethylolpropane trimethacrylate, trimethylolpropane triacrylate, and allyl methacrylate.

From the viewpoint of ease of odor reduction, the compound (C) is preferably a compound having a structure represented by the following formula (C1).

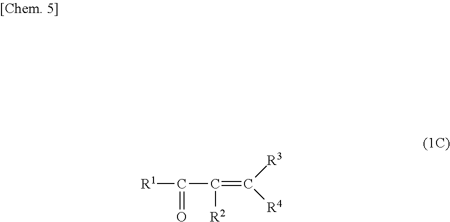

In formula (1C), R¹ represents an organic group, R² represents a hydrogen atom or an alkyl group, and R³ and R⁴ each independently represent a hydrogen atom or an organic group. In a case where R¹ is an organic group, R¹ may be an organic group containing a nitrogen atom or an organic group containing an oxygen atom. In a case where R² is an alkyl group, R² may be a methyl group, an ethyl group, or a propyl group. From the viewpoint of ease of odor reduction, the compound (C) may be a compound having a plurality of structures represented by formula (1C).

The molecular weight of the compound (C) may be 150 or more, 200 or more, 250 or more, 270 or more, or 300 or more from the viewpoint of ease of odor reduction, and may be 1000 or less, 800 or less, 600 or less, 500 or less, or 400 or less from the same viewpoint.

### <Filling Material (D)>

The composition may contain a filling material (filler). Examples of the filling material include at least one selected from the group consisting of glass powder such as a glass bead, a glass balloon, or a glass flake, silicate mineral, alumina, magnesium oxide, antimony oxide, barium ferrite, strontium ferrite, beryllium oxide, magnesium hydroxide, aluminum hydroxide, basic magnesium carbonate, magnesium carbonate, carbonate mineral, calcium sulfate, magnesium sulfate, basic magnesium sulfate, calcium sulfite, cadmium sulfide, asbestos, mica, calcium carbonate, talc, silica, calcium silicate, hydrotalcite, kaolin, diatomaceous earth, graphite, pumice, ebony powder, cotton flock, cork powder, barium sulfate, fluororesin, cellulose powder, and wood powder.

In a case where the filling material is in particulate form, the shape thereof is not limited, and may be a plate shape, a needle shape, or a fiber shape.

From the viewpoint of the rigidity, impact resistance, and dimensional stability of the composition and the molded body, the filling material is preferably an inorganic filling material, and more preferably talc which is a plate-shaped silicate mineral.

### <Oxazoline-Based Compound (E)>

The composition may contain an oxazoline-based compound. Examples of the oxazoline-based compound include monoxazoline compounds such as 2-oxazoline, 2-methyl-2-oxazoline, 2-phenyl-2-oxazoline, 2,5-dimethyl-2-oxazoline, and 2,4-diphenyl-2-oxazoline; dioxazoline compounds such as 2,2′-(1,3-phenylene)-bis(2-oxazoline), 2,2′-(1,2-ethylene)-bis(2-oxazoline), 2,2′-(1,4-butylene)-bis(2-oxazoline), and 2,2′-(1,4-phenylene)-bis(2-oxazoline); and oxazoline copolymers such as a styrene-2-isopropenyl-2-oxazoline copolymer.

The oxazoline-based compound preferably contains a compound having a plurality of oxazoline groups in one molecule from the viewpoint of ease of odor reduction.

The molecular weight of the oxazoline-based compound may be 200000 or less, 170000 or less, 10000 or less, 5000 or less, 2000 or less, 1000 or less, or 500 or less, or may be 100 or more, 150 or more, or 200 or more.

### (Additive)

The composition may contain components other than the above components (hereinafter, also referred to as “other components”) as necessary. Examples of the other components include thermoplastic resins (polystyrenes (for example, polystyrene, poly(p-methylstyrene), poly(α-methylstyrene), and AS (copolymer of acrylonitrile and styrene) resins), ABS (copolymer of acrylonitrile, butadiene, and styrene) resins, AAS (copolymer of special acrylic rubber, acrylonitrile, and styrene) resins, ACS (copolymer of acrylonitrile, chlorinated polyethylene, styrene) resins, polychloroprene, chlorinated rubber, polyvinyl chloride, polyvinylidene chloride, acrylic resins, copolymer resins of ethylene and vinyl alcohol, fluororesins, polyacetal, grafted polyphenylene ether resins and polyphenylene sulfide resins, polyurethane, polyamide, polyester resins (for example, polyethylene terephthalate and polybutylene terephthalate), polycarbonate, polysulfone, polyether ether ketone, polyether sulfone, aromatic polyester resins, polybutadiene, 1,2-polybutadiene, polyisoprene, copolymers of styrene and butadiene, copolymers of butadiene and acrylonitrile, natural rubber, and the like), epoxy resins, diallyl phthalate prepolymers, silicone resins, silicone rubber, epichlorohydrin rubber, acrylic rubber, PLA resins produced by polymerizing a plant-derived monomer extracted from a bio raw material (polylactic acid), neutralizing agents, antioxidants, ultraviolet absorbers, nucleating agents, lubricants, antistatic agents, antiblocking agents, processing aids, organic peroxides, colorants (inorganic pigment, organic pigment, pigment dispersant, and the like), foaming agents, foaming nucleating agents, plasticizers, flame retardants, crosslinking agents, crosslinking aids, brightness enhancement agents, antibacterial agents, and light diffusing agents. The composition may contain only one of the above components, or may contain a combination of two or more thereof.

### (Composition)

The content of the polymer (A) may be 50% by mass or more, 60% by mass or more, 70% by mass or more, or 80% by mass or more based on the total amount of the composition. The content of the polymer (A) may be 95% by mass or less, 90% by mass or less, or 85% by mass or less based on the total amount of the composition.

The content of the aliphatic polyester-based polymer (B) may be 0.10% by mass or more, 10% by mass or more, 2% by mass or more, 3% by mass or more, 4% by mass or more, or 5% by mass or more based on the total amount of the composition. The content of the aliphatic polyester-based polymer (B) may be 30% by mass or less, 25% by mass or less, 20% by mass or less, 15% by mass or less, or 10% by mass or less based on the total amount of the composition.

From the viewpoint of ease of odor reduction, the content of the compound (C) having a carbon-carbon double bond may be 0.01% by mass or more, 0.05% by mass or more, 0.1% by mass or more, 0.15% by mass or more, or 0.2% by mass or more based on the total amount of the composition. The content of the compound (C) having a carbon-carbon double bond may be 5% by mass or less, 4% by mass or less, 3% by mass or less, 2% by mass or less, or 1% by mass or less based on the total amount of the composition.

The content of the compound (C) having a carbon-carbon double bond with respect to 100 parts by mass of the polymer (A) may be 0.01 parts by mass or more, 0.05 parts by mass or more, 0.1 parts by mass or more, 0.15 parts by mass or more, or 0.2 parts by mass or more from the viewpoint of ease of odor reduction, and may be 10 parts by mass or less, 8 parts by mass or less, 6 parts by mass or less, 5 parts by mass or less, 4 parts by mass or less, or 3 parts by mass or less from the same viewpoint. From these viewpoints, the content of the compound (C) having a carbon-carbon double bond with respect to 100 parts by mass of the aliphatic polyester-based polymer (B) may be 0.01 to 10 parts by mass, 0.1 to 6 parts by mass, or 0.2 to 4 parts by mass.

The content of the compound (C) having a carbon-carbon double bond with respect to 100 parts by mass of the aliphatic polyester-based polymer (B) may be 0.1 parts by mass or more, 0.3 parts by mass or more, 0.5 parts by mass or more, 1 part by mass or more, 2 parts by mass or more, 3 parts by mass or more, 4 parts by mass or more, or 5 parts by mass or more from the viewpoint of ease of odor reduction, and may be 100 parts by mass or less, 80 parts by mass or less, 60 parts by mass or less, 40 parts by mass or less, 20 parts by mass or less, or 10 parts by mass or less from the same viewpoint. From these viewpoints, the content of the compound (C) having a carbon-carbon double bond with respect to 100 parts by mass of the aliphatic polyester-based polymer (B) may be 0.3 to 100 parts by mass, 1 to 60 parts by mass, or 3 to 20 parts by mass.

The content of the aliphatic polyester-based polymer (B) may be 0.1 to 30 parts by mass, 2 to 20 parts by mass, or 5 to 10 parts by mass with respect to a total of 100 parts by mass of the polymer (A), the aliphatic polyester-based polymer (B), and the compound (C) having a carbon-carbon double bond.

From the viewpoint of ease of odor reduction, the content of the compound (C) having a carbon-carbon double bond may be 0.01 to 5 parts by mass, 0.05 to 4 parts by mass, or 0.1 to 3 parts by mass with respect to a total of 100 parts by mass of the polymer (A), the aliphatic polyester-based polymer (B), and the compound (C) having the carbon-carbon double bond.

In a case where the composition contains a filling material (D), the content of the filling material (D) may be 0.1 to 40 parts by mass, 1 to 30 parts by mass, or 5 to 20 parts by mass with respect to a total of 100 parts by mass of the polymer (A), the aliphatic polyester-based polymer (B), and the compound (C) having a carbon-carbon double bond.

In a case where the composition contains an oxazoline-based compound (E), the content of the oxazoline-based compound (E) is 0.1 to 10 parts by mass, 0.3 to 5 parts by mass, 0.5 to 3 parts by mass with respect to a total of 100 parts by mass of the polymer (A), the aliphatic polyester-based polymer (B), and the compound (C) having a carbon-carbon double bond.

### <Method for Producing Composition>

A method for producing the above composition according to the present embodiment will be described.

The method for producing a composition according to the present embodiment includes at least a step of mixing the polymer (A), the aliphatic polyester-based polymer (B), and the compound (C) having a carbon-carbon double bond. Specifically, the composition can be obtained by melt-kneading the raw material components described above. The temperature during the melt-kneading may be 180° C. or higher, 180° C. to 300° C., or 180° C. to 250° C.

For the melt-kneading, a Banbury mixer, a single-screw extruder, a co-rotating twin-screw extruder, or the like can be used.

The order of kneading the raw material components is not particularly limited. For example, the raw material components may be kneaded collectively, or some components among the raw material components may be kneaded, and then the resulting kneaded product and other components may be kneaded.

The shape of the composition is not particularly limited, and may be, for example, a strand shape, a sheet shape, a flat plate shape, or a pellet shape. The pellet-shaped composition can be produced by, for example, forming a strand-shaped composition and then cutting the strand-shaped composition into an appropriate length.

From the viewpoint of molding processability of the composition and production stability in a case of producing a molded body, the shape of the composition before the molded body is subjected to the molding processing is preferably a pellet shape with a length of about 1 to 50 mm.

### <Use of Molded Body>

Examples of the use of the molded body according to the present invention include a component for automobiles, a material for household electric appliances, a material for OA devices, a building material, drainage equipment, a toilet material, various tanks, a container, and a sheet.

Examples of the component for automobiles include interior components such as a door trim, a pillar, an instrumental panel, a console, a rocker panel, an armrest, a door inner panel, and a spare tire cover, exterior components such as a bumper, a spoiler, a fender, a side step, and a door outer panel, components such as an air intake duct, a coolant reservoir tank, a radiator reserve tank, a window washer tank, a fender liner, and a fan, and integrally molded components such as a front end panel.

Examples of the material for household electric appliances include materials for a washing machine (outer tub, inner tub, lid, pulsator, balancer, washing pan, and the like), materials for a dryer (exterior, inner box, lid, and the like), materials for a vacuum cleaner, materials for a rice cooker, materials for a pot, materials for a warming machine, materials for a dishwasher, and materials for an air cleaner.

Examples of the material for OA devices and a media-related material include a case of a magnetic recording medium or an optical recording medium, components for a personal computer, and components for a printer.

Examples of the building material include frames for hardening concrete and the like, and wall members. Examples of the drainage equipment include pipes and pump parts. Examples of the material for containers include food filling containers, transportation containers, and garment containers. Examples thereof also include transportation pallets.

### EXAMPLES

Hereinafter, the present invention will be specifically described with reference to Examples. However, the present invention is not limited to Examples described below.

### [Components Used in Examples and Comparative Examples]

In Examples and Comparative Examples, the following raw materials were used.

### Component A: Polymer

### (A-1) Heterophasic Propylene Polymer Material

A heterophasic propylene polymer material (A-1) as a propylene-based polymer containing (a) 84 parts by mass of a propylene homopolymer component as the polymer (I) and (b) 16 parts by mass of an ethylene-propylene random copolymer component as the polymer (II) was produced by a liquid-gas phase polymerization method using a polymerization catalyst obtained by the method described in Example 1 of Japanese Unexamined Patent Application Publication No. 2004- 182981. The melt flow rate of A-1 (230° C., load: 2.16 kg) was 30 g/10 min.

### (A-2) Heterophasic Propylene Polymer Material

A heterophasic propylene polymer material (A-1) as a propylene-based polymer containing (a) 79 parts by mass of a propylene homopolymer component as the polymer (I) and (b) 21 parts by mass of an ethylene-propylene random copolymer component as the polymer (II) was produced by a liquid-gas phase polymerization method using a polymerization catalyst obtained by the method described in Example 1 of Japanese Unexamined Patent Application Publication No. 2004-182981. The melt flow rate of A-1 (230° C., load: 2.16 kg) was 27 g/10 min.

### Component B: Aliphatic Polyester-Based Polymer

### (B-1) Poly(3-Hydroxybutyrate)

manufactured by Newlight Technologies
Melt flow rate (190° C., load: 2.16 kg): 8.6 g/10 min

### Component C: Compound (C) Having Carbon-Carbon Double Bond

(C-1) N,N′-m-phenylenebismaleimide
“Sumifine BM” manufactured by Sumika Chemtex Co., Ltd.

### (C-2) Trimethylolpropane Trimethacrylate

“Hi-Cross MS50” manufactured by Seiko Chemical Co., Ltd.

### Component D: Filling Material

### (D-1) Talc

“MWUPN-TT-H” manufactured by HAYASHI KASEI CO., LTD.

### Component E: Oxazoline-Based Compound

(E-1) 2,2′-(1,3-phenylene)bis(2-oxazoline)
“CP resin A component 1,3-PBO” manufactured by MIKUNI PHARMACEUTICAL INDUSTRIAL CO., LTD.
   (E-2) Styrene-2-isopropenyl-2-oxazoline Copolymer)
“EPOCROS RPS-1005” manufactured by NIPPON SHOKUBAI CO., LTD.

The following components were used as other additives.
Hydrotalcite “DHT-4C” manufactured by Kyowa Chemical Industry Co., Ltd.
“SUMILIZER GA80” (antioxidant) manufactured by Sumitomo Chemical Co., Ltd.
“Irgafos168” (antioxidant) manufactured by BASF SE
“SUMILIZER TPM” (antioxidant) manufactured by Sumitomo Chemical Co., Ltd.
“Uvinul 5050H” (light stabilizer) manufactured by BASF SE
“Sumisorb 400” manufactured by Sumika Chemtex Co., Ltd.
“ALFLOW H-50P” (lubricant) manufactured by NOF Corporation
“TS-5” (nonionic surfactant) manufactured by Kao Corporation

### Example 1

All of the components, including 85 parts by mass of a heterophasic propylene polymer material (A-1), 5 parts by mass of poly(3-hydroxybutyrate) (B-1), 0.5 parts by mass of N,N′-m-phenylene bismaleimide (C-1), 10 parts by mass of talc (D-1), and 0.03 parts by mass of “DHT-4C”, 0.1 parts by mass of “SUMILIZER GA-80”, 0.05 parts by mass of “Irgafos 168”, 0.02 parts by mass of “SUMILIZER TPM”, 0.15 parts by mass of “Uvinul 5050H”, 0.2 parts by mass of “Sumisorb 400”, 0.05 parts by mass of “Alflow H-50P”, and 0.3 parts by mass of “TS-5” as additives, were mixed, and the mixture was charged through a raw material charging port on the most upstream of a twin-screw kneader (twin-screw extruder) (“TEX4αII” manufactured by The Japan Steel Works, Ltd.), and melt-kneaded to obtain pellets. Melt-kneading was performed under conditions of a cylinder temperature of 170° C., a discharge amount of 60 kg/hour, and a screw rotation speed of 160 rpm, a molten strand extruded from a die hole was immersed in a cooling water tank, cooled and solidified, and cut with a pelletizer to obtain a pellet-shaped composition. The MFR (190° C.) of the obtained composition was measured according to the method specified in JIS K7210, and found to be 14.5 g/10 min.

### Examples 2 to 11 and Comparative Example 1

Pellet-shaped compositions were obtained in the same manner as in Example 1 according to the compositions in Tables 1 and 2.

### <Evaluation of Odor>

The composition of each of Examples and Comparative Examples was supplied to an injection molding machine (“M70-type injection molding machine” manufactured by MEIKI CO., LTD.), and a flat plate of the composition having a length of 60 mm, a width of 60 mm, and a thickness of 2.0 mm was molded at a cylinder temperature setting of 190° C., a mold temperature of 40° C., a filling pressure of 15 MPa, a pressure holding of 4.3 MPa, a pressure holding time of 40 seconds, and a total cycle time of 60 seconds. Next, the flat plate was machined into a size of 60 mm in length, 30 mm in width, and 2.0 mm in thickness. A total of 3 machined flat plates were placed in an odorless glass bottle with a volume of 0.5 L, the glass bottle was sealed with a lid, heated at 80° C. for 2 hours in an oven, and then left to stand at 60° C. for a while. Next, an odor test was performed on the flat plate of the composition in the glass bottle by three or more panelists according to the following method. Furthermore, the odor of the molded flat plate was evaluated in the same manner as described above except that the cylinder set temperature was set to 230° C. The evaluation results are shown in Tables 1 and 2. Note that “-” in the table means not measured.

The degree of the odor was scored by panelists based on the following criteria.
1 point: No odor is felt.
2 points: A smell is felt, but it is not unpleasant.
3 points: The odor is clearly felt, but it is still not unpleasant.
4 points: Unpleasant odor.
Score 5: Very unpleasant odor.
6 points: Unbearable odor.

The scores given by the panelists were summed, and the total score was divided by the number of panelists to calculate the average score of odor. From this average score, the degree of odor in the composition of each of Examples or Comparative Examples was evaluated.

### <Evaluation of Molding Appearance>

The composition of each of Examples and Comparative Examples was metered and plasticized under the conditions of a cylinder set temperature of 220° C. and a mold cooling temperature of 50° C., a molten resin was then retained in the cylinder for 15 minutes, and thereafter, injection molding was performed to prepare a rectangular parallelepiped test piece of 400 mm×100 mm×3 mm. A SE180D-type injection molding machine manufactured by Sumitomo Heavy Industries, Ltd. was used for injection molding. The appearance of the test piece was visually evaluated according to the following criteria. The evaluation results are shown in Tables 1 and 2. Note that “-” in the table means not measured.

A: There is no abnormality on the surface of the molded body.

B: Silver streaking is observed on the surface of the molded body, but the portion of the silver streaking is half or less of the area of the surface of the molded body.

C: Silver streaking occurs on the entire surface of the molded body.

TABLE 1

| | | Example | Example | Example | Example | Example | Example | Example | Example |
|---|---|---|---|---|---|---|---|---|---|
| | | 1 | 2 | 3 | 4 | 5 | 6 | 7 | 8 |
| Component | A-1 | 85 | 85 | 85 | 85 | 85 | 80 | 80 | 85 |
| | B-1 | 5 | 5 | 5 | 5 | 5 | 10 | 10 | 5 |
| | C-1 | 0.5 | — | 0.1 | 0.2 | 3 | 0.5 | 0.1 | 0.1 |
| | C-2 | — | 0.5 | — | — | — | — | — | — |
| | D-1 | 10 | 10 | 10 | 10 | 10 | 10 | 10 | 10 |
| | E-1 | — | — | — | — | — | 0.5 | 0.5 | — |
| | E-2 | — | — | — | — | — | — | — | 0.5 |
| Evaluation | Odor at | 2.9 | 3.2 | 3.0 | 2.9 | 2.9 | 2.9 | 3.0 | 2.9 |
| | 190° C. | | | | | | | | |
| | Odor at | — | — | — | — | — | 3.6 | 3.4 | — |
| | 230° C. | | | | | | | | |
| | Appearance | — | — | — | B | — | A | A | C |

TABLE 2

| | | Example | Example | Example | Comparative |
|---|---|---|---|---|---|
| | | 9 | 10 | 11 | Example 1 |
| Com- | A-2 | 95 | 95 | 90 | 95 |
| ponent | B-1 | 5 | 5 | 10 | 5 |
| | C-1 | 0.1 | 0.1 | 0.1 | — |
| | E-1 | — | 0.5 | 0.5 | — |
| Eval- | Odor | 2.7 | 2.9 | 3.3 | 3.8 |
| uation | at | | | | |
| | 190° C. | | | | |
| | Odor | 3.8 | 3.5 | 3.9 | 4.1 |
| | at | | | | |
| | 230° C. | | | | |

1. A composition comprising:
a polymer (A);
an aliphatic polyester-based polymer (B); and
a compound (C) having a carbon-carbon double bond.

2. The composition according to claim 1, wherein the polymer (A) comprises an olefin-based polymer.

3. The composition according to claim 1, wherein the polymer (A) comprises a propylene-based polymer.

4. The composition according to claim 1, wherein the aliphatic polyester-based polymer (B) comprises a polyhydroxyalkanoate-based polymer.

5. The composition according to claim 1, wherein the compound (C) comprises a compound comprising at least one selected from the group consisting of a maleimide group, an acrylic group, a methacrylic group, an allyl group, and a styryl group.

6. The composition according to claim 1, wherein the compound (C) comprises a compound having a plurality of carbon-carbon double bonds (where, a carbon-carbon double bond constituting an aromatic ring is excluded).

7. The composition according to claim 1, wherein the compound (C) is 0.3 to 100 parts by mass with respect to 100 parts by mass of the aliphatic polyester-based polymer (B).

8. The composition according to claim 1, wherein the aliphatic polyester-based polymer (B) is 0.1 to 30 parts by mass and the compound (C) is 0.1 to 3 parts by mass, with respect to a total of 100 parts by mass of the polymer (A), the aliphatic polyester-based polymer (B), and the compound (C).

9. The composition according to claim 1, further comprising
a filling material (D), wherein
the filling material (D) is 0.1 to 40 parts by mass with respect to a total of 100 parts by mass of the polymer (A), the aliphatic polyester-based polymer (B), and the compound (C).

10. The composition according to claim 1, further comprising
an oxazoline-based compound (E), wherein
the oxazoline-based compound (E) is 0.1 to 10 parts by mass with respect to a total of 100 parts by mass of the polymer (A), the aliphatic polyester-based polymer (B), and the compound (C).

11. The composition according to claim 10, wherein the oxazoline-based compound (E) is a compound having a plurality of oxazoline groups.

12. The composition according to claim 10, wherein a molecular weight of the oxazoline-based compound (E) is 500 or less.

13. A molded body formed by molding the composition according to claim 1.

14. The molded body according to claim 13, wherein the molded body is a component for automobiles.
